(19) United States
(12) Patent Application Publication
(10) Pub. No.: US 2009/0135121 A1
(43) Pub. Date: May 28, 2009

(54) DRIVING CIRCUIT AND RELATED METHOD OF A DISPLAY APPARATUS

(76) Inventors: Wei-Shan Chiang, Tai-Chung City (TW); Wei-Yang Ou, Kao-Hsiung City (TW); Ming-Huang Liu, Taipei Hsien (TW); Meng-Yong Lin, Hsinchu City (TW); Chen-Hsien Han, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/101,157

(22) Filed: Apr. 11, 2008

(30) Foreign Application Priority Data
Nov. 22, 2007 (TW) 096144286

(51) Int. Cl. G09G 3/36

(52) U.S. Cl. 345/90

(57) ABSTRACT

A driving circuit includes a data driving circuit, including a plurality of driving circuit modules respectively corresponding to a plurality of channels; and a control unit, positioned in at least one circuit sub-module of each driving circuit module of the plurality of driving circuit module. When the control unit is enabled, the control unit controls the driving circuit modules output auxiliary display data having a predetermined gray value to drive the display apparatus. When the control unit is disabled, utilizing the driving circuit module to drive the display apparatus according to original display data. A related method of a display apparatus is also disclosed.

### BACKGROUND OF THE INVENTION

1. Field of the Invention

The invention relates to a driving circuit and related method of a display apparatus, and more particularly, to a driving circuit and related method utilized for inserting black frames of a display apparatus.

2. Description of the Prior Art

To improve motion blur of a liquid crystal display (LCD), the simplest method is to insert a black frame between two normal frames to reduce motion blur. Recently, many prior art driving methods for inserting a black frame are widely used. While not modifying the pixel design of the LCD, the method of inserting the black frame is to divide the display time of a frame into two segments, where the first segment shows original image data and the second segment shows black image data. However, under this driving method, two image data are transmitted in the display time of the original frame, and this results in heavier loading of a central processing unit (CPU), a timing controller (TCON) or a data bus. Additionally, the data bus is an apparatus with higher power consumption, so using this driving method will consume more power.

### SUMMARY OF THE INVENTION

It is therefore an objective of the present invention to provide a driving circuit and related method utilized for inserting black frames of a display apparatus, to solve the above-mentioned problems.

According to one embodiment of the present invention, a driving circuit of a display apparatus comprises a data driving circuit comprising a plurality of driving circuit modules corresponding to a plurality of channels, and a control unit positioned in at least one circuit sub-module of each driving circuit module of the plurality of driving circuit module. When the control unit is enabled, utilizing the control unit to control the driving circuit modules output auxiliary display data having a predetermined gray value to drive the display. When the control unit is disabled, utilizing the driving circuit module to drive the display according to original display data.

According to one embodiment of the present invention, a driving method of a display apparatus comprises providing a data driving circuit wherein comprising a plurality of driving circuit modules corresponding to a plurality of channels, and positioning a control unit in at least one circuit sub-module of each driving circuit module of the plurality of driving circuit module. When the control unit is enabled, utilizing the control unit to control the driving circuit modules output auxiliary display data having a predetermined gray value to drive the display. When the control unit is disabled, utilizing the driving circuit module to drive the display according to original display data.

According to the driving circuit and the driving method provided by the present invention, only one image data (that is the original image data) is transmitted in a scanning time of a scan line and therefore, the loadings of the data bus of the CPU will not increase. Compared with the prior art driving methods of inserting the black frame, utilizing the driving method of the present invention can decrease power consumption of the CPU, the timing controller, or the data bus.

These and other objectives of the present invention will no doubt become obvious to those of ordinary skill in the art after reading the following detailed description of the preferred embodiment that is illustrated in the various Figures and drawings.

### BRIEF DESCRIPTION OF THE DRAWINGS

FIG. 1 is a diagram illustrating a data driving circuit according to one embodiment of the present invention.

FIG. 2 is a diagram illustrating that the control unit is integrated into the level shifter.

FIG. 3 is a diagram illustrating connections between pixels in the display panel and the data driving circuit.

FIG. 4 is a diagram illustrating relative voltage levels among output voltages of the driving circuit.

FIG. 5 is a diagram illustrating control signals of the data driving circuit and the scan driving circuit.

FIG. 6 is a diagram illustrating control signals during the time T₁, T₂, and T₄ shown in FIG. 5.

FIG. 7 is a diagram illustrating control signals during the time T₃ shown in FIG. 5.

FIG. 8 is a diagram illustrating control signals during the time T₅ shown in FIG. 5.

FIG. 9 is a circuit diagram illustrating the control unit integrated into the buffer amplifier according to a first embodiment of the present invention.

FIG. 10 is a circuit diagram illustrating the control unit integrated into the buffer amplifier according to a second embodiment of the present invention.

FIG. 11 is a diagram illustrating control signals of the data driving circuit when the display apparatus is driven under dot-inversion.

### DETAILED DESCRIPTION

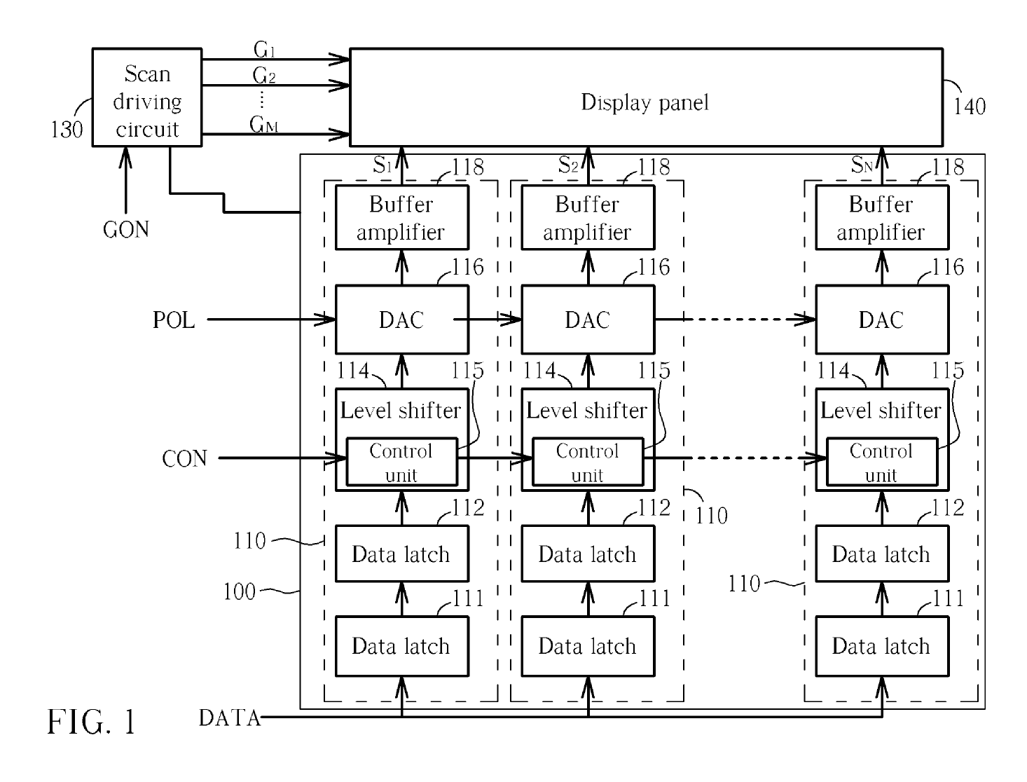

Please refer to FIG. 1. FIG. 1 is a diagram illustrating a data driving circuit 100 according to one embodiment of the present invention. As shown in FIG. 1, the data driving circuit 100 comprises a plurality of driving circuit modules 110 respectively corresponding to a plurality of channels, where each driving circuit module 110 comprises a plurality of circuit sub-modules. The plurality of circuit sub-modules are two data latches 111 and 112, a level shifter 114, a digital to analog converter 116, and a buffer amplifier 118, where the level shifter 114 further comprises a control unit 115, and the control unit 115 of each driving circuit module 110 of the data driving circuit 100 receives the same controlling signal CON. Additionally, the data driving circuit 100 is coupled to a display panel 140 and a scan driving circuit 130 to transmit display data of a plurality of data output channel S₁, S₂, . . . , S_{N} corresponding to a plurality of driving circuit module 110 to the display panel 140. When the controlling signal CON is enabled, the scan driving circuit 130 is communicated to enable a function GON to enable all the scan lines.

In practice, the control unit 115 is integrated into one of the circuit sub-modules of the driving circuit module 110 (in this embodiment, the control unit 115 is integrated into the level shifter 114), and is utilized to receive a controlling signal to enable or disable the control unit 115. In this embodiment, when the control unit 115 is enabled, the control unit 115 is utilized to control the driving circuit modules to output auxiliary display data having a predetermined gray value to drive the display apparatus. When the control unit 115 is disabled, the driving circuit module 110 is utilized to drive the display apparatus according to original display data.

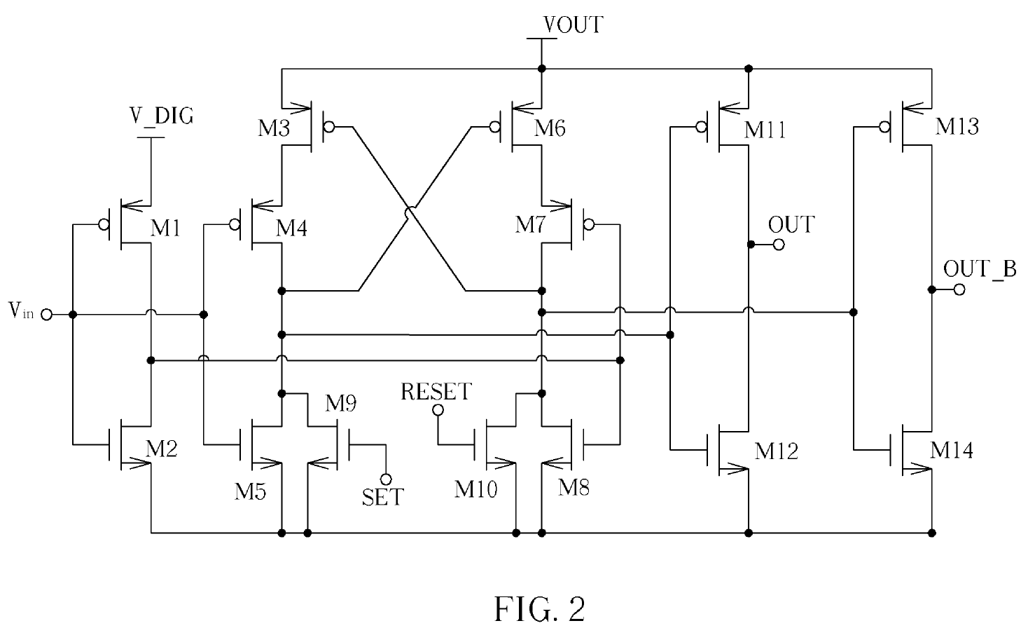

Please refer to FIG. 2. FIG. 2 is a diagram illustrating that the control unit 115 is integrated into the level shifter 114. As shown in FIG. 2, in this embodiment, the control unit 115 is a selector and enables a set switch SET or a reset switch RESET to output the auxiliary display data having the predetermined gray value according to a polarity of the original display data. In this embodiment, the predetermined gray value is zero. As shown in FIG. 2, the level shifter 114 comprises a plurality of transistors M1-M14, and a plurality of voltage sources V_DIG, VOUT, and VGND. The level shifter 114 is utilized to raise the voltage level of an input digital signal Vin, where the voltage range of the input digital signal Vin is about 0V-1.8V, and the voltage range of output digital signals OUT and OUT_B are about 0V-6V. The following are variations of each voltage signal along a time-axis when the set switch SET or the reset switch RESET of the level shifter 114 is enabled.

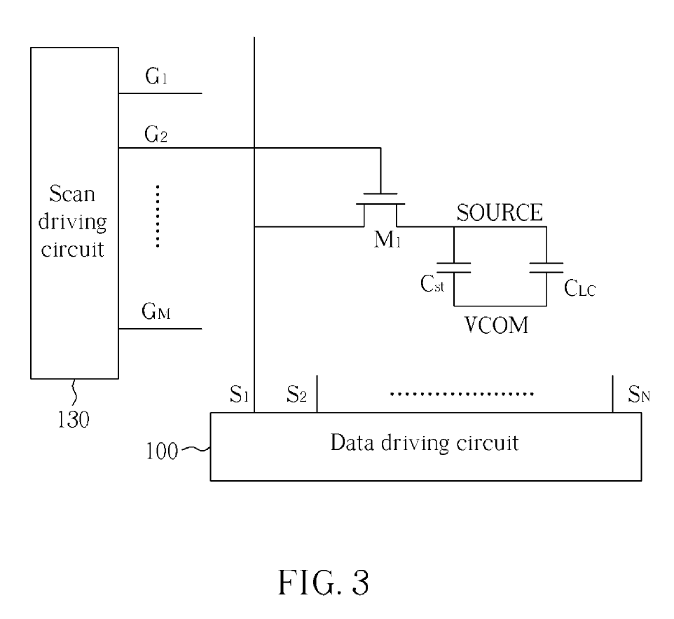

FIG. 3 is a diagram illustrating connections between pixels in the display panel 140 and the data driving circuit 100. As shown in FIG. 3, taking a pixel as an example, when the scan line is enabled (i.e., transistor M1 is enabled), the driving circuit module 110 of the data driving circuit 100 transmits display data of the output channel S₁ to the pixel to make the voltage of a pixel electrode SOURCE equal to the display data transmitted from the driving circuit module 110. Then the gray value of the pixel is determined according to the voltage difference between the electrode SOURCE and a common electrode VCOM.

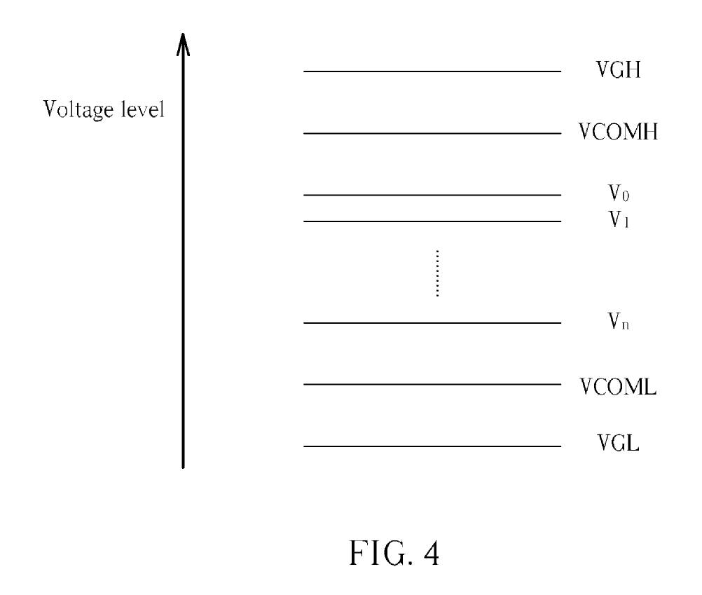

The level shifter 114 shown in FIG. 2 is applied to a driving circuit having two common electrode voltages. FIG. 4 is a diagram illustrating relative voltage levels among output voltages of the driving circuit. From high to low, the output voltages of the driving circuit are VGH, VCOMH, V₀, V₁, V₂, . . . , Vₙ, VCOML, VGL, where VGH is the voltage of the scan line when the scan line is enabled, VCOMH is a first common electrode voltage, and V₀, V₁, V₂, . . . , Vₙ are respectively correspond to driving voltages of each gray level (i.e., the output voltages of the driving circuit module 110). Here, VCOML is a second common electrode voltage, and VGL is the voltage of the scan line when the scan line is disabled.

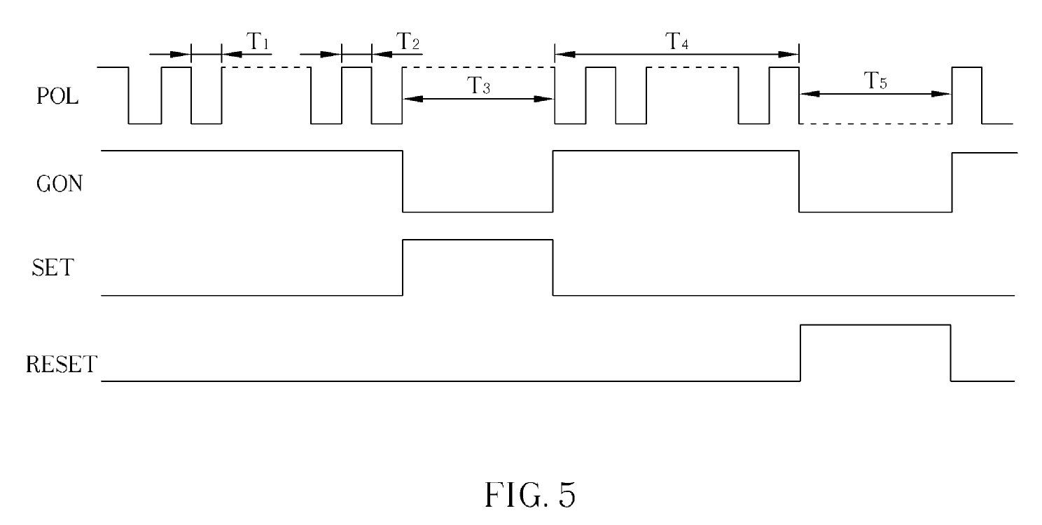

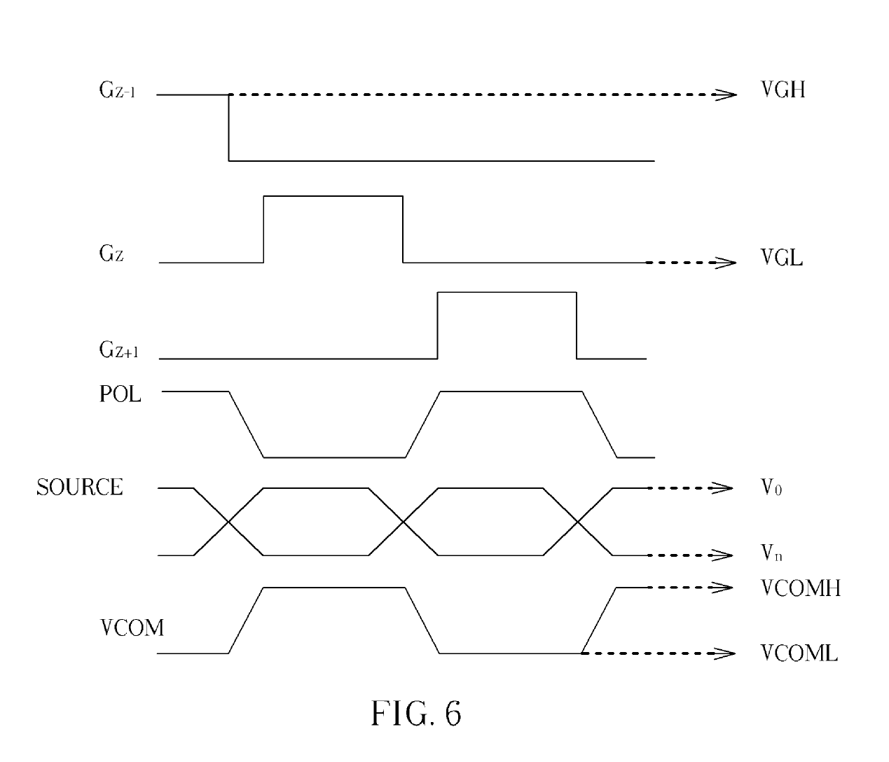

FIG. 5 is a diagram illustrating control signals of the data driving circuit 100 and the scan driving circuit 130. During the time T₁, T₂, and T₄, the display apparatus outputs an original image; that is, the data driving circuit 100 and the scan driving circuit 130 drive the display apparatus according to original display data. During the time T₃ and T₅, the data driving circuit 100 outputs auxiliary display data having zero gray values (corresponding to black-level display data) to drive the display apparatus. FIG. 6 is a diagram illustrating control signals during the time T₁, T₂, and T₄ shown in FIG. 5. As shown in FIG. 6, G_{z-1}, G_{z}, and G_{z+1} respectively represent signals of three continuous scan lines: POL represents polarity signal, SOURCE represents the voltage of a pixel electrode (the driving signal outputted from the driving circuit module 110 of the data driving circuit 100), and VCOM represents a common electrode voltage. Additionally, in this embodiment, only one scan line is enabled at a time, and the voltage levels of the polarity signal POL and the common electrode VCOM are in opposite phase: when the polarity signal POL is at a high voltage level, the voltage of the common electrode VCOM is VCOML, and when the polarity signal POL is low, the voltage of the common electrode VCOM is VCOMH. The control signal diagram shown in FIG. 6 is a timing diagram of prior art control signals. A person skilled in this art can readily understand the operations, and therefore further description is omitted here.

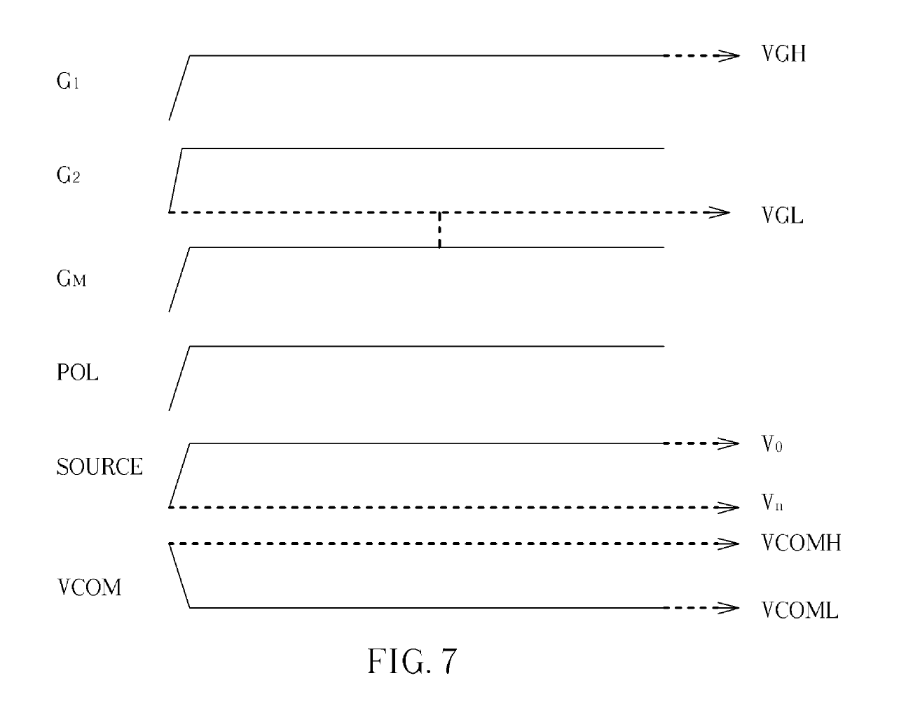

Please refer to FIG. 7. FIG. 7 is a diagram illustrating control signals during the time T₃ shown in FIG. 5. During the time T₃ shown in FIG. 5, the function GON and the set switch SET shown in FIG. 2 are enabled. As shown in FIG. 7, the voltages of signals of all the scan lines G₁, G₂, . . . , G_{M} are all VGH (all the scan line are enabled), the polarity signal POL is at a high voltage level, and the voltage of the common electrode VCOM is VCOML. Because the set switch SET shown in FIG. 2 is enabled, assuming that the inputted digital signal Vin is 6-bits, the outputted digital signal OUT shown in FIG. 2 is “111111”, corresponding to the voltage V₀. At this time, the voltage difference between the pixel electrode SOURCE and the common electrode VCOM is a maximum value and therefore, for a normally white display apparatus, the gray values of all the pixels are zero.

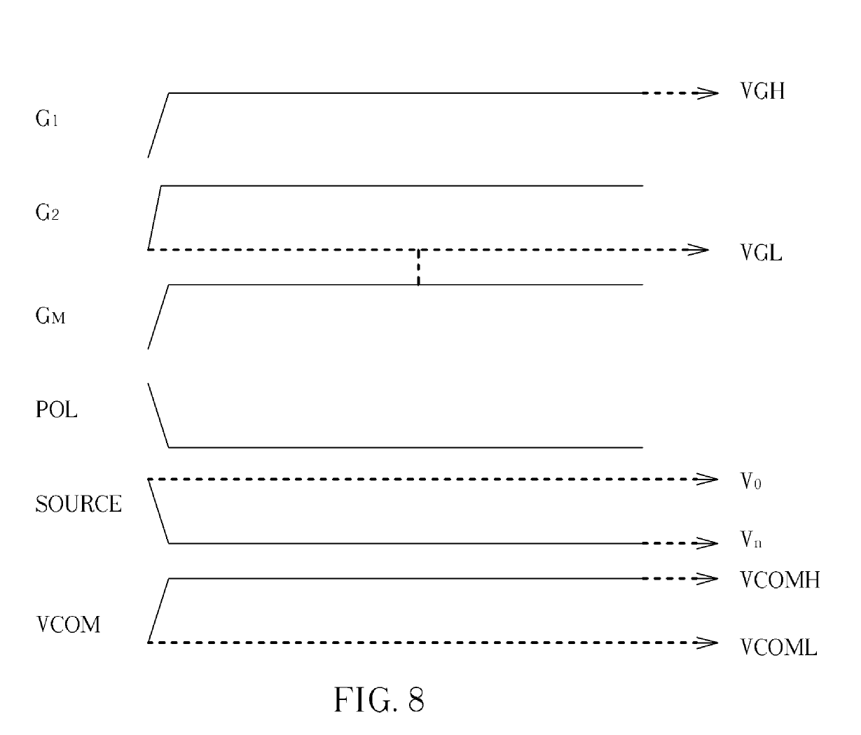

Similarly, when the polarity signal POL is at low voltage level and the voltage of the common electrode VCOM is VCOMH, the reset switch RESET is enabled to generate a black frame. FIG. 8 is a diagram illustrating control signals during the time T₅ shown in FIG. 5. During the time T₅ shown in FIG. 5, the function GON and the reset switch RESET shown in FIG. 2 are enabled. As shown in FIG. 8, the voltages of signals of all the scan lines G₁, G₂, . . . , G_{M} are all VGH (all the scan line are enabled), the polarity signal POL is at low voltage level, and the voltage of the common electrode VCOM is VCOMH. Because the reset switch RESET shown in FIG. 2 is enabled, assuming that the inputted digital signal Vin is 6-bits, the outputted digital signal OUT shown in FIG. 2 is “000000”, corresponding to the voltage Vₙ. At this time, the voltage difference between the pixel electrode SOURCE and the common electrode VCOM is a maximum value and therefore, for a normally white display apparatus, the gray values of all the pixels are zero.

Using the above-mentioned set switch SET and reset switch RESET to switch the driving circuit module 110 to output display data having zero gray values is in accordance with the polarity signal POL: that is, a black frame is generated (inserted) without varying other signals (e.g., common electrode VCOM and the polarity signal POL).

Additionally, in this embodiment, the function GON is used to display black display data across the whole image at one time. However, considering certain factors, all the scan lines are not suitable to be enabled at the same time or the whole image is improper to display black display data at the same time. Therefore, the function GON can determine the number of enabled scan lines by the designer's consideration. For example, a display panel can be divided into three regions, and once all the scan lines in only one region are enabled to display black image in this region. As another example, consider a panel where the input signals of the scan lines are inputted into the display panel through two opposite sides of the display panel: during one period, all the odd scan lines are enabled, and during the next period, all the even scan lines are enabled. There alternative designs are all in the scope of the present invention.

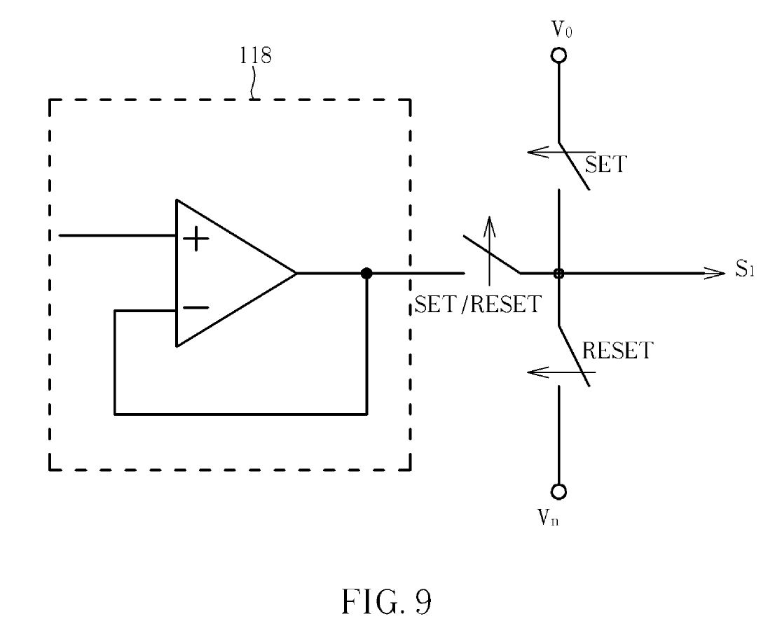

The above-mentioned integration of the control unit 115 into the level shifter 114 is used to generate digital display data having zero gray value (i.e., “111111” or “000000” as mentioned). However, the control unit 115 can also be integrated into the buffer amplifier 118 to generate analog display data having zero gray value (i.e., output V₀ or Vₙ). FIG. 9 is a circuit diagram illustrating the control unit 115 integrated into the buffer amplifier 118 according to a first embodiment of the present invention. As shown in FIG. 9, the control unit 115 is integrated into an output node of the buffer amplifier 118, where the output node of the buffer amplifier 118 is connected to a set switch SET, a reset switch RESET, and a set/reset switch SET/RESET, and the set switch SET is connected to a voltage source having the voltage V₀, and the reset switch RESET is connected to a voltage source having the voltage Vₙ. In this embodiment, enabling the set switch SET or the reset switch RESET is according to the polarity signal POL, which is the same as the above embodiment that the control unit is integrated into the level shifter 114. When the set switch SET is enabled, set/reset switch SET/RESET is disabled, and the output voltage of the buffer amplifier 118 is V₀. At this time, the voltage difference between the output voltage of the buffer amplifier 118 and the common electrode VCOM (having the voltage VCOML) is a maximum value; when the reset switch SET is enabled, set/reset switch SET/RESET is disabled, and the output voltage of the buffer amplifier 118 is Vₙ. At this time, the voltage difference between the output voltage of the buffer amplifier 118 and the common electrode VCOM (having the voltage VCOMH) is a maximum value. Therefore, for a normally white display apparatus, the gray values of all the pixels are zero.

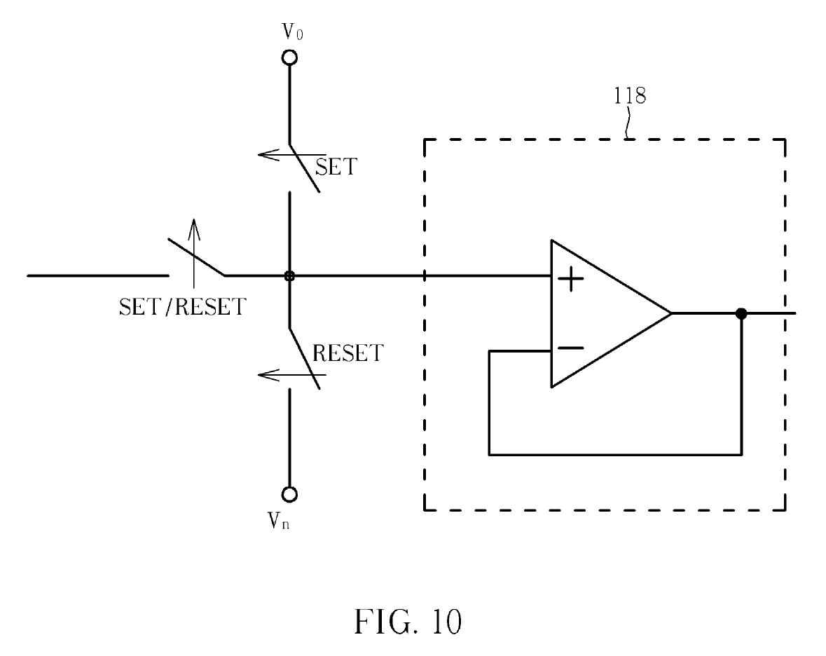

Similarly, the control unit 115 can also be integrated into an input node of the buffer amplifier 118. FIG. 10 is a circuit diagram illustrating the control unit 115 integrated into the buffer amplifier 118 according to a second embodiment of the present invention. As shown in FIG. 10, the control unit 115 is integrated into the input node of the buffer amplifier 118, where the input node of the buffer amplifier 118 is connected to a set switch SET, a reset switch RESET, and a set/reset switch SET/RESET. Additionally, the set switch SET is connected to a voltage source having the voltage V₀, and the reset switch RESET is connected to a voltage source having the voltage Vₙ. The operations of this embodiment are the same as the operations of the embodiment shown in FIG. 9. As a person skilled in this art can readily applied to this embodiment after reading the above disclosure, further descriptions are omitted here.

It should be noted that the above-mentioned embodiments are all applied for normally white display apparatus. By changing some circuit elements or by adjusting the voltage(s), however, the present invention can also be applied for normally black display apparatus.

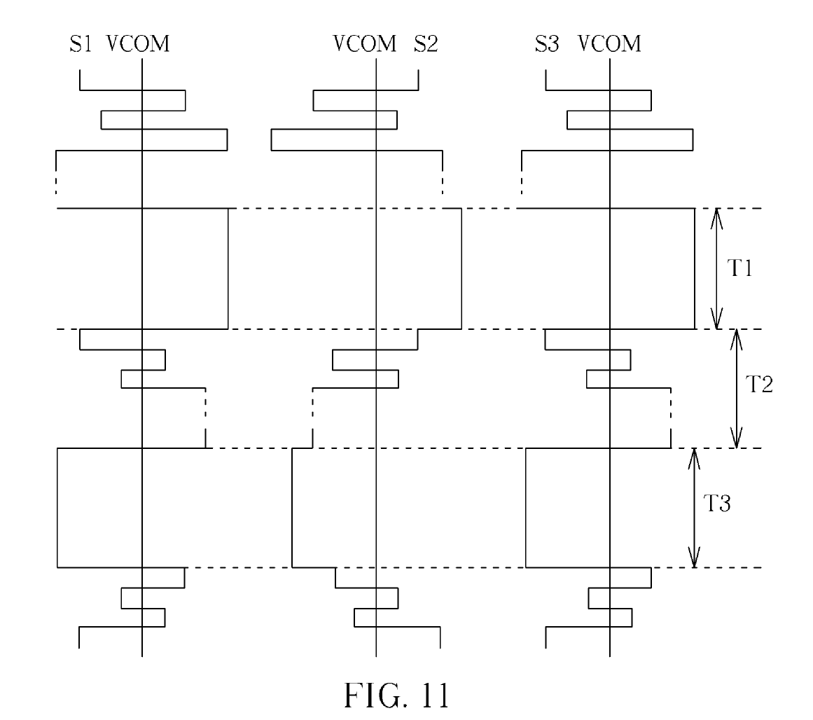

Additionally, when the display apparatus is driven by dot-inversion or line-inversion, the voltage of the common electrode is a constant value, and the present invention can also be applied to these cases. FIG. 11 is a diagram illustrating control signals of the data driving circuit when the display apparatus is driven under dot-inversion. As shown in FIG. 11, during times T₁ and T₃, the driving circuit module 110 receives a controlling signal to generate display data having zero gray value according to the polarity signal POL. Methods for generating the display data having zero gray value are similar to that in the embodiments shown in FIG. 2 and FIG. 9. As a person skilled in this art can readily applied to this embodiment after reading the above disclosure, further descriptions are omitted here.

Briefly summarizing the above-mentioned driving circuit and related method of the display apparatus. In the present invention, a data driving circuit includes a plurality of driving circuit modules respectively corresponding to a plurality of channels, and each driving circuit module comprises a plurality of circuit sub-modules. The control unit is positioned in the circuit sub-module having the same functions of each driving circuit module. When the control unit is enabled, utilizing the control unit to control the driving circuit modules output auxiliary display data having a predetermined gray value to drive the display apparatus. When the control unit is disabled, utilizing the driving circuit module to drive the display apparatus according to original display data.

Those skilled in the art will readily observe that numerous modifications and alterations of the device and method may be made while retaining the teachings of the invention.

What is claimed is:

1. A driving method of a display apparatus, comprising:
providing a data driving circuit, comprising a plurality of driving circuit modules respectively corresponding to a plurality of channels;
positioning a control unit in at least one circuit sub-module of each driving circuit module of the plurality of driving circuit modules;
when the control unit is enabled, utilizing the control unit to control the driving circuit modules output auxiliary display data having a predetermined gray value to drive the display apparatus; and
when the control unit is disabled, utilizing the driving circuit module to drive the display apparatus according to original display data.

2. The driving method of claim 1, wherein positioning a control unit in at least one circuit sub-module of each driving circuit module of the plurality of driving circuit module comprises: positioning the control unit in the circuit sub-module having the same functions of each driving circuit module of the plurality of driving circuit modules; and the driving method further comprises:
generating a control signal to the plurality of control units corresponding to the plurality of driving circuit modules to control the plurality of control units being enabled or being disabled at the same time.

3. The driving method of claim 1, wherein the control unit is a selector utilized to selectively output first auxiliary display data corresponding to the predetermined gray value or second auxiliary display data according to polarity of the original display data.

4. The driving method of claim 1, wherein the driving circuit module comprises at least one data latch, a level shifter, a digital-to-analog converter, and a buffer amplifier, and the control unit is integrated in the data latch, the level shifter, the digital-to-analog converter, or the buffer amplifier.

5. The driving method of claim 1, wherein when the control unit is enabled, at least one scan line is enabled.

6. The driving method of claim 1, wherein when the control unit is enabled, all scan lines are enabled.

7. The driving method of claim 1, wherein when the control unit is enabled, all odd scan lines are enabled.

8. The driving method of claim 1, wherein when the control unit is enabled, all even scan lines are enabled.

9. The driving method of claim 1, wherein the predetermined gray value is zero, and the images of the display apparatus are black.

10. A driving circuit of a display apparatus, comprising:
a data driving circuit, comprising a plurality of driving circuit modules respectively corresponding to a plurality of channels; and
a control unit, positioned in at least one circuit sub-module of each driving circuit module of the plurality of driving circuit module, and when the control unit is enabled, the control unit controls the driving circuit modules output auxiliary display data having a predetermined gray value to drive the display apparatus; and when the control unit is disabled, the driving circuit module drives the display apparatus according to original display data.

11. The driving circuit of claim 10, wherein at least one circuit sub-module has the same functions of each driving circuit module of the plurality of driving circuit module positions the control unit, and the plurality of control units corresponding to the plurality of driving circuit modules receive a control signal to control the plurality of control units being enabled or disabled at the same time.

12. The driving circuit of claim 10, wherein the control unit is a selector utilized to selectively output first auxiliary display data corresponding to the predetermined gray value or second auxiliary display data according to polarity of the original display data.

13. The driving circuit of claim 10, wherein the driving circuit module comprises at least one data latch, a level shifter, a digital-to-analog converter, and a buffer amplifier, and the control unit is integrated in the data latch, the level shifter, the digital-to-analog converter, or the buffer amplifier.

14. The driving circuit of claim 10, wherein when the control unit is enabled, at least one scan line is enabled.

15. The driving circuit of claim 10, wherein when the control unit is enabled, all scan lines are enabled.

16. The driving circuit of claim 10, wherein when the control unit is enabled, all odd scan lines are enabled.

17. The driving circuit of claim 10, wherein when the control unit is enabled, all even scan lines are enabled.

18. The driving circuit of claim 10, wherein the predetermined gray value is zero, and the images of the display apparatus are black.
